(19) United States
(12) Patent Application Publication
(10) Pub. No.: US 2018/0338645 A1
(43) Pub. Date: Nov. 29, 2018

(54) SPOUTING INSTRUMENT

(71) Applicant: LIXIL Corporation, Tokyo (JP)

(72) Inventor: Tatsuyuki TAKEUCHI, Tokyo (JP)

(21) Appl. No.: 16/056,999

(22) Filed: Aug. 7, 2018

Related U.S. Application Data
(63) Continuation of application No. PCT/JP2017/002268, filed on Jan. 24, 2017.

(30) Foreign Application Priority Data
Mar. 23, 2016 (JP) 2016-059098
Mar. 23, 2016 (JP) 2016-059099

(51) Int. Cl. A47K 3/00; A61H 33/02

(52) U.S. Cl. CPC A47K 3/00; A61H 2033/021; A61H 33/027

(57) ABSTRACT

A spouting instrument is mounted on the surface side of a bathtub and spouts out water through a first spout port to the bathtub. To a first water supply port of the spouting instrument, water from a water supply source is supplied. The water supplied through the first water supply port flows through a first flow passage to the first spout port. The first flow passage includes a first ejector. The first ejector mixes air into the water flowing from the first water supply port to produce foam and sends the foam to the first spout port.

### CROSS-REFERENCE TO RELATED APPLICATIONS

This application is based upon and claims the benefit of priority from the prior Japanese Patent Applications No. 2016-059098, filed on Mar. 23, 2016, and Japanese Patent Applications No. 2016-059099, filed on Mar. 23, 2016, and International Application No. PCT/JP2017/002268, filed on Jan. 24, 2017, the entire contents of which are incorporated herein by reference.

### BACKGROUND OF THE INVENTION

### 1. Field of the Invention

The present invention relates to a spouting instrument used for a bathtub.

### 2. Description of the Related Art

Japanese Unexamined Patent Application Publication No. 2011-130911 (JP-A-2011-130911) discloses a spouting instrument provided with a leg part that doubles as a pipe and fixed by inserting the leg part into an insertion hole provided on the flange part of the bathtub. The leg part of the spouting instrument is connected to a hot water supply device and a foam supply device via a switching device, and the spouting instrument selectively spouts out foam or hot water.

The spouting instrument described in JP-A-2011-130911 requires installation of the switching device and the foam supply device in the rear of the bathtub to spout out hot water and foam. However, there is a problem in that the switching device and foam supply device cannot be installed when there is not sufficient space therefor in the rear of the bathtub. Also, while foam produced in the foam supply device passes through the pipe connecting the foam supply device and the switching device and the pipe connecting the switching device and the leg part of the spouting instrument before reaching the spouting instrument, some foam bubbles may burst because of the pipe resistance, so that the foam may become coarse.

### SUMMARY OF THE INVENTION

The first invention has been made in view of the above-described circumstances, and a purpose thereof is to provide a spouting instrument capable of producing foam.

Meanwhile, when the foam bubbles spouted out from the spouting instrument collide with the surface of the bathtub or the like, re-bubbling, in which boundaries between foam bubbles are broken by the force provided at the collision, may occur. When re-bubbling occurs, the foam bubbles are changed to large foam bubbles, so that improvement therefor is desired. The spouting instrument described in JP-A-2011-130911 spouts out hot water for shoulders and foam through the same spout port. As a result of study of this structure, the inventor has recognized that there is room for improvement from the perspective of restraint of re-bubbling.

The second invention has been made in view of the above-described circumstances, and a purpose thereof is to provide a spouting instrument that spouts out water and foam and is suitable to restrain re-bubbling caused when foam bubbles collide with the bathtub.

One embodiment of the first invention relates to a spouting instrument. The spouting instrument is mounted on the surface side of a bathtub and includes a first spout port through which water is spouted out to the bathtub, a first water supply port to which water from a water supply source is supplied, and a first flow passage through which water supplied through the first water supply port flows to the first spout port, wherein the first flow passage includes a first ejector that mixes air into water flowing from the first water supply port to produce foam and sends the foam to the first spout port.

In this embodiment, the spouting instrument is mounted on the surface side of the bathtub. To the first water supply port of the spouting instrument, water from the water supply source is supplied, and the spouting instrument spouts out water through the first spout port to the bathtub. The first flow passage, through which water supplied through the first water supply port flows to the first spout port, includes the first ejector. The first ejector mixes air into water flowing from the first water supply port to produce foam and sends the foam to the first spout port. In this way, foam can be produced in the spouting instrument.

One embodiment of the second invention relates to a spouting instrument. The spouting instrument spouts out water and foam to a bathtub and includes spout ports separated into two tiers arranged vertically, in which foam is spouted out through a first spout port on the lower tier side, and water is spouted out through a second spout port on the upper tier side.

In this embodiment, when the water spout position is arranged at a certain height, the foam spout position can be arranged lower than the water spout position, so that re-bubbling can be further restrained compared to the case where the water spout position and the foam spout position are the same.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a configuration diagram of a bathtub device including a spouting instrument according to a first embodiment;

FIG. 2 is a sectional view that schematically shows a configuration of the spouting instrument according to the first embodiment;

FIG. 3 is a table that shows exemplary spouting states of the spouting instrument related to the opening and closing of water stop valves according to the first embodiment;

FIG. 4 is a longitudinal sectional view of a spouting instrument according to a second embodiment;

FIG. 5 is a table that shows exemplary spouting states of the spouting instrument related to the opening and closing of water stop valves according to the second embodiment;

FIG. 6 is a schematic diagram used to describe another example regarding the arrangement of the spouting instrument;

FIG. 7 is a schematic diagram used to describe yet another example regarding the arrangement of the spouting instrument;

FIG. 8 is a configuration diagram of a bathtub device including a spouting instrument according to a third embodiment;

FIG. 9 is a front view of the spouting instrument according to the third embodiment;

FIG. 10 is a plan view of the spouting instrument according to the third embodiment; and

FIG. 11 is a schematic diagram used to describe a state where the spouting instrument according to the third embodiment is used.

### DETAILED DESCRIPTION OF THE INVENTION

The invention will now be described by reference to the preferred embodiments. This does not intend to limit the scope of the present invention, but to exemplify the invention.

In the following, like reference characters denote like or corresponding constituting elements and members in each drawing, and the same description will be omitted as appropriate. Also, the dimensions of a member may be appropriately enlarged or reduced in each drawing in order to facilitate understanding. Further, in each drawing, part of a member less important in describing embodiments may be omitted.

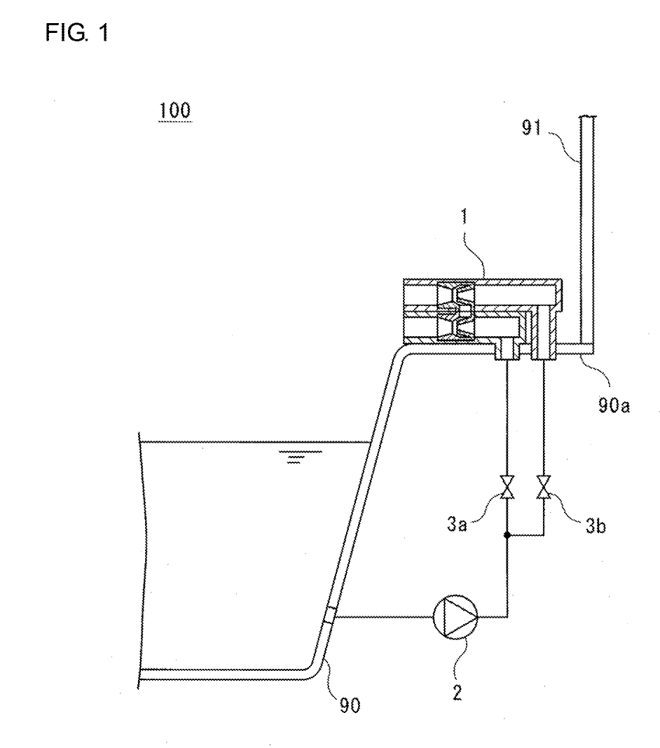

There will be described the first invention based on preferred embodiments with reference to FIGS. 1 through 7.

### First Embodiment

FIG. 1 is a configuration diagram of a bathtub device 100 including a spouting instrument 1 according to the first embodiment. The bathtub device 100 comprises a bathtub 90 that stores hot water, a wall panel 91, the spouting instrument 1, a water supply source 2, and water stop valves 3a and 3b. The spouting instrument 1 is mounted to a flange part 90a of the bathtub 90, and the bathtub 90 receives water and foam spouted out from the spouting instrument 1. The wall panel 91 is mounted on the flange part 90a of the bathtub 90. The wall panel 91 and other wall panels surround the bathtub 90 and the washing place, not illustrated, on all sides, thereby forming a bathroom space.

The water supply source 2 is a pump device that suctions water stored in the bathtub 90 and supplies the water to the spouting instrument 1. The water supply source 2 may also be the type that receives water from a hot water supply device, besides the type that uses the circulation of the water stored in the bathtub 90 as shown in FIG. 1. The pipe through which water is supplied from the water supply source 2 to the spouting instrument 1 is bifurcated and connected to the spouting instrument 1 via the water stop valves 3a and 3b. The water supply source 2 and the water stop valves 3a and 3b are provided on the rear side of the bathtub 90. Meanwhile, the spouting instrument 1 is mounted on the surface side of the bathtub 90, which is the inner side of the bathroom space. The spouting instrument 1 is mounted on an upper end part of the bathtub 90 or at a position slightly lower than the upper end part such as to spout out water and foam from the outside, not the inside, of the water stored in the bathtub 90, i.e., from a position higher than the water surface, to the bathtub 90. The spouting instrument 1 has a function to spout out the water supplied from the water supply source 2 as it is, and a function to mix air into the water supplied from the water supply source 2 to produce foam and spout it out. The spouting instrument 1 can be used for both the cases where the supplied water does not include a liquid containing a foaming component and where the supplied water includes such a liquid. When the water supplied from the water supply source 2 does not include a liquid containing a foaming component, air bubbles are produced within the water in the spouting instrument 1 and spouted out from the spouting instrument 1. When the water supplied from the water supply source 2 includes a liquid containing a foaming component, foam produced with the liquid is spouted out from the spouting instrument 1. Depending on the type, concentration, and the like of the liquid mixed into the water, the foam is spouted out from the spouting instrument 1 in various states, such as the state of mousse-like fine foam and the state of foam bubbles having relatively large sizes. In this way, based on the user's preference, the spouting instrument 1 is operated to produce various forms of foam different in bubble size, durability, and texture, depending on whether or not the water supplied from the water supply source 2 includes a liquid containing a foaming component, and the type, concentration, and the like of the liquid.

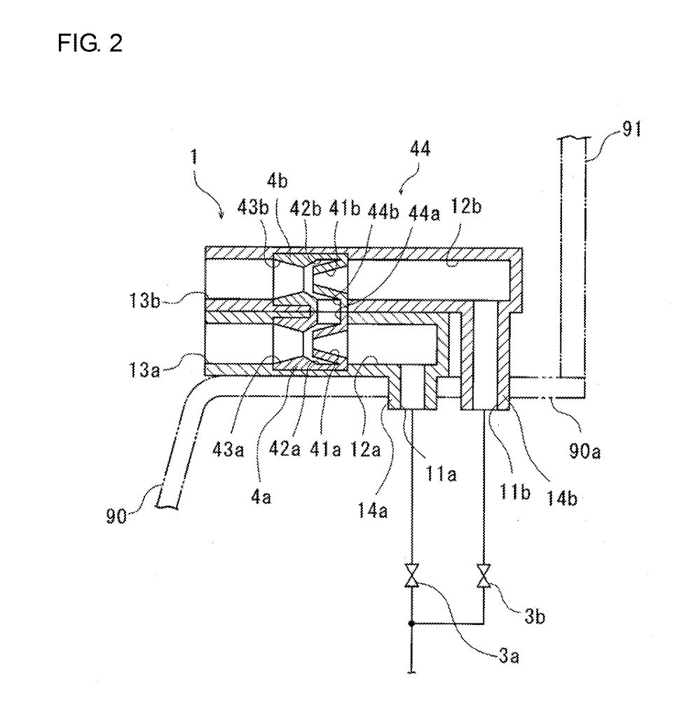

FIG. 2 is a sectional view that schematically shows a configuration of the spouting instrument according to the first embodiment. The spouting instrument 1 comprises a first water supply port 11a, a second water supply port 11b, a first flow passage 12a, a second flow passage 12b, a first spout port 13a, and a second spout port 13b. Also, a first ejector 4a is provided midway along the first flow passage 12a, and a second ejector 4b is provided midway along the second flow passage 12b.

The first water supply port 11a is an opening at an end part of a water supply pipe 14a and is connected to the pipe extending from the water stop valve 3a. Also, the second water supply port 11b is an opening at an end part of a water supply pipe 14b and is connected to the pipe extending from the water stop valve 3b. The water supply pipes 14a and 14b are inserted into holes provided on the flange part 90a of the bathtub 90 to be fixed.

The first flow passage 12a communicates, on one end side thereof, with the water supply passage within the water supply pipe 14a, and water supplied to the first water supply port 11a flows through the first flow passage 12a to the first spout port 13a provided on the other end side of the first flow passage 12a. The first spout port 13a faces the bathroom space side, and water and foam is spouted out through the first spout port 13a to the inside of the bathtub 90. The first flow passage 12a includes the first ejector 4a at a midway thereof, and a portion between the first ejector 4a and the first water supply port 11a constitutes an upstream-side flow passage portion, and a portion between the first ejector 4a and the first spout port 13a constitutes a downstream-side flow passage portion. Meanwhile, the second flow passage 12b communicates, on one end side thereof, with the water supply passage within the water supply pipe 14b, and water supplied to the second water supply port 11b flows through the second flow passage 12b to the second spout port 13b provided on the other end side of the second flow passage 12b. The second spout port 13b faces the bathroom space side, and water and foam is spouted out through the second spout port 13b to the inside of the bathtub 90. The second flow passage 12b includes the second ejector 4b at a midway thereof, and a portion between the second ejector 4b and the second water supply port 11b constitutes an upstream-side flow passage portion, and a portion between the second ejector 4b and the second spout port 13b constitutes a downstream-side flow passage portion.

The first ejector 4a includes a nozzle part 41a, an air suctioning chamber 42a, and a discharge passage 43a. The nozzle part 41a is formed in a tapered shape such that the flow passage area of the opening portion on the upstream side of the first flow passage 12a is larger, whereas the flow passage area of the opening portion on the downstream side of the first flow passage 12a is smaller. The shape of the opening portions of the nozzle part 41a may be a circle, an ellipse, or a rectangle.

The air suctioning chamber 42a forms a space for accommodating the tip portion of the nozzle part 41a. The downstream side of the air suctioning chamber 42a has a tapered shape such that the flow passage area on the upstream side is larger, whereas the flow passage area on the downstream side is smaller. The tip opening portion of the nozzle part 41a is positioned midway along the tapered portion on the downstream side of the air suctioning chamber 42a.

The discharge passage 43a is a flow passage of which the upstream side communicates with the air suctioning chamber 42a and the downstream side communicates with the downstream side of the first flow passage 12a, and the discharge passage 43a is also formed in a tapered shape. In the discharge passage 43a, the flow passage area on the upstream side is smaller, whereas the flow passage area on the downstream side is larger.

The second ejector 4b includes a nozzle part 41b, an air suctioning chamber 42b, and a discharge passage 43b. The nozzle part 41b is formed in a tapered shape such that the flow passage area of the opening portion on the upstream side of the second flow passage 12b is larger, whereas the flow passage area of the opening portion on the downstream side of the second flow passage 12b is smaller. The shape of the opening portions of the nozzle part 41b may be a circle, an ellipse, or a rectangle.

The air suctioning chamber 42b forms a space for accommodating the tip portion of the nozzle part 41b. The downstream side of the air suctioning chamber 42b has a tapered shape such that the flow passage area on the upstream side is larger, whereas the flow passage area on the downstream side is smaller. The tip opening portion of the nozzle part 41b is positioned midway along the tapered portion on the downstream side of the air suctioning chamber 42b.

The discharge passage 43b is a flow passage of which the upstream side communicates with the air suctioning chamber 42b and the downstream side communicates with the downstream side of the second flow passage 12b, and the discharge passage 43b is also formed in a tapered shape. In the discharge passage 43b, the flow passage area on the upstream side is smaller, whereas the flow passage area on the downstream side is larger.

The air suctioning chamber 42a of the first ejector 4a communicates with the air suctioning chamber 42b of the second ejector 4b via a communication passage 44. The communication passage 44 includes a communication passage 44a extending from the air suctioning chamber 42a of the first ejector 4a, and a communication passage 44b extending from the air suctioning chamber 42b of the second ejector 4b.

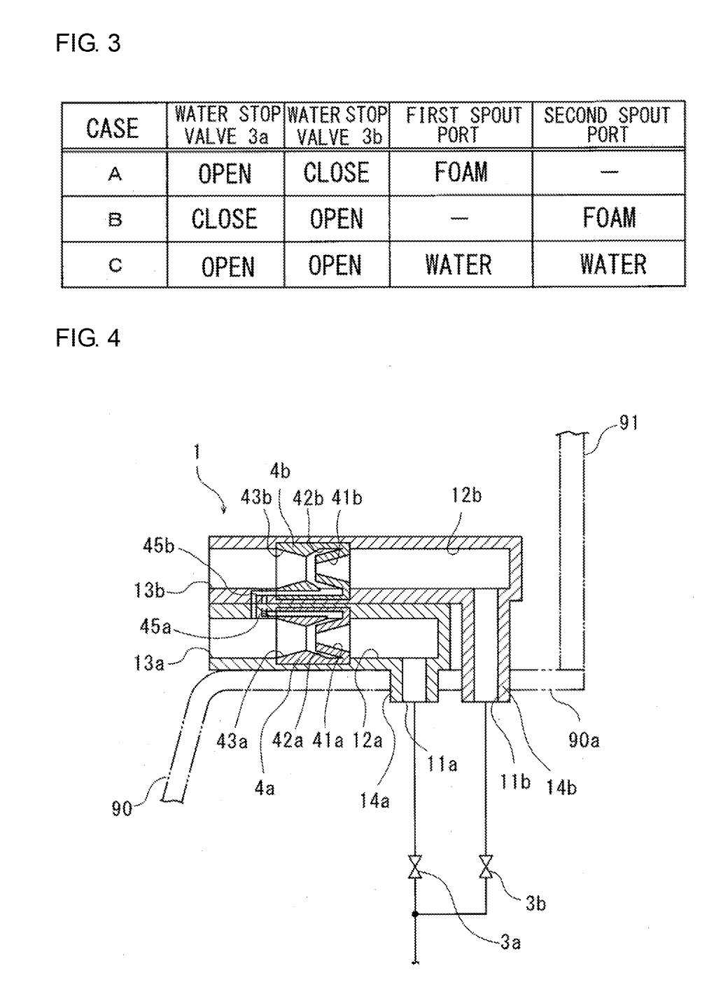

There will now be described the operation of the spouting instrument 1. FIG. 3 is a table that shows exemplary spouting states of the spouting instrument 1 related to the opening and closing of the water stop valves 3a and 3b. In the case A shown in FIG. 3, the water stop valve 3a is placed in the open state, and the water stop valve 3b is placed in the closed state. Accordingly, water is supplied to the first water supply port 11a but is not supplied to the second water supply port 11b in the spouting instrument 1. The water supplied to the first water supply port 11a flows from the upstream side of the first flow passage 12a to the nozzle part 41a of the first ejector 4a, and is then pressurized in the nozzle part 41a to be squirted to the discharge passage 43a. Since the pressure in the nozzle part 41a is higher while the pressure in the discharge passage 43a is lower, air is drawn into the air suctioning chamber 42a. Into the air suctioning chamber 42a, air is drawn through an air passage constituted by the communication passage 44, the air suctioning chamber 42b in the second ejector 4b, the discharge passage 43b, the downstream side of the second flow passage 12b, and the second spout port 13b. In the first ejector 4a, the air drawn into the air suctioning chamber 42a is mixed with water squirted from the nozzle part 41a, so that foam is produced. The foam thus produced flows through the discharge passage 43a and the downstream-side flow passage of the first flow passage 12a to be spouted out through the first spout port 13a. Through the second spout port 13b, neither water nor foam is spouted out.

In the case B, the water stop valve 3a is placed in the closed state, and the water stop valve 3b is placed in the open state. Accordingly, water is supplied to the second water supply port 11b but is not supplied to the first water supply port 11a in the spouting instrument 1. The water supplied to the second water supply port 11b flows from the upstream side of the second flow passage 12b to the nozzle part 41b of the second ejector 4b, and is then pressurized in the nozzle part 41b to be squirted to the discharge passage 43b. Since the pressure in the nozzle part 41b is higher while the pressure in the discharge passage 43b is lower, air is drawn into the air suctioning chamber 42b. Into the air suctioning chamber 42b, air is drawn through an air passage constituted by the communication passage 44, the air suctioning chamber 42a in the first ejector 4a, the discharge passage 43a, the downstream side of the first flow passage 12a, and the first spout port 13a. In the second ejector 4b, the air drawn into the air suctioning chamber 42b is mixed with water squirted from the nozzle part 41b, so that foam is produced. The foam thus produced flows through the discharge passage 43b and the downstream-side flow passage of the second flow passage 12b to be spouted out through the second spout port 13b. Through the first spout port 13a, neither water nor foam is spouted out. When the shape and position of the nozzle part 41b, the size of the air suctioning chamber 42b, and the shape of the discharge passage 43b in the second ejector 4b are made different from those in the first ejector 4a, the size of the foam bubbles produced in the case A and that in the case B can be made different from each other.

In the case C, the water stop valve 3a is placed in the open state, and the water stop valve 3b is also placed in the open state. Accordingly, water is supplied to the first water supply port 11a and the second water supply port 11b in the spouting instrument 1. The water supplied to the first water supply port 11a flows from the upstream side of the first flow passage 12a to the nozzle part 41a of the first ejector 4a, and is then pressurized in the nozzle part 41a to be squirted to the discharge passage 43a; thereafter, the water flows through the discharge passage 43a and the downstream side of the first flow passage 12a to be spouted out through the first spout port 13a. Similarly, the water supplied to the second water supply port 11b flows from the upstream side of the second flow passage 12b to the nozzle part 41b of the second ejector 4b, and is then pressurized in the nozzle part 41b to be squirted to the discharge passage 43b; thereafter, the water flows through the discharge passage 43b and the downstream side of the second flow passage 12b to be spouted out through the second spout port 13b. Since the downstream side of each of the first flow passage 12a and the second flow passage 12b is filled with water, air can be drawn into neither the air suctioning chamber 42a nor the air suctioning chamber 42b. Accordingly, the spouting instrument 1 spouts out water through the first spout port 13a and the second spout port 13b.

In the following, the features of the spouting instrument 1 according to the first embodiment will be described.

The spouting instrument 1 according to the first embodiment is mounted on the surface side of the bathtub 90 and spouts out water through the first spout port 13a to the bathtub 90. To the first water supply port 11a of the spouting instrument 1, water from the water supply source 2 is supplied. The water supplied through the first water supply port 11a then flows through the first flow passage 12a to the first spout port 13a. The first flow passage 12a includes the first ejector 4a. The first ejector 4a mixes air into the water flowing from the first water supply port 11a to produce foam and sends the foam to the first spout port 13a. Thus, foam can be produced in the spouting instrument 1. Since foam can be produced in the spouting instrument 1, the foam supply device and the switching device need not be installed in the rear of the bathtub 90.

The spouting instrument 1 also includes the second spout port 13b through which water is spouted out to the bathtub 90. To the second water supply port 11b of the spouting instrument 1, water from the water supply source 2 is supplied. The water supplied through the second water supply port 11b then flows through the second flow passage 12b to the second spout port 13b. The second flow passage 12b includes the second ejector 4b. The second ejector 4b mixes air into the water flowing from the second water supply port 11b to produce foam and sends the foam to the second spout port 13b. Accordingly, foam can be spouted out through the first spout port 13a or the second spout port 13b. Water can also be spouted out through the first spout port 13a and the second spout port 13b.

### Second Embodiment

FIG. 4 is a sectional view that schematically shows a configuration of the spouting instrument 1 according to the second embodiment. The spouting instrument 1 according to the second embodiment includes a first communication passage 45a through which the air suctioning chamber 42a of the first ejector 4a communicates with a flow passage portion of the second flow passage 12b downstream from the first ejector 4a, and a second communication passage 45b through which the air suctioning chamber 42b of the second ejector 4b communicates with a flow passage portion of the first flow passage 12a downstream from the second ejector 4b. The flow passage area of the connection port provided on the air suctioning chamber 42a and connected to the first communication passage 45a is made smaller than the flow passage area of the connection port provided on the air suctioning chamber 42b and connected to the second communication passage 45b.

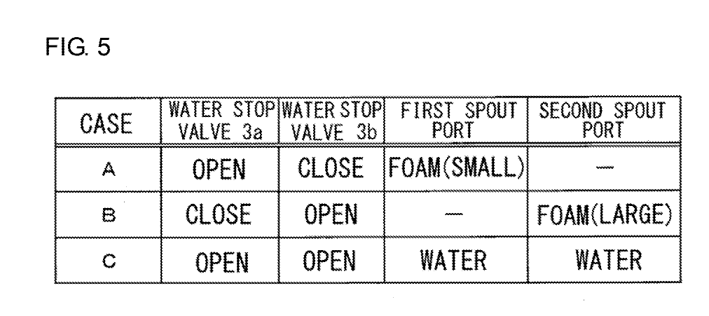

FIG. 5 is a table that shows exemplary spouting states of the spouting instrument 1 related to the opening and closing of the water stop valves 3a and 3b. In the case A shown in FIG. 5, the water stop valve 3a is placed in the open state, and the water stop valve 3b is placed in the closed state. Accordingly, water is supplied to the first water supply port 11a but is not supplied to the second water supply port 11b in the spouting instrument 1. The water supplied to the first water supply port 11a flows from the upstream side of the first flow passage 12a to the nozzle part 41a of the first ejector 4a, and is then pressurized in the nozzle part 41a to be squirted to the discharge passage 43a. Since the pressure in the nozzle part 41a is higher while the pressure in the discharge passage 43a is lower, air is drawn into the air suctioning chamber 42a. Into the air suctioning chamber 42a, air is drawn through an air passage constituted by the first communication passage 45a, the downstream side of the second flow passage 12b, and the second spout port 13b. In the first ejector 4a, the air drawn into the air suctioning chamber 42a is mixed with water squirted from the nozzle part 41a, so that foam is produced. Since the flow passage area of the connection port provided on the air suctioning chamber 42a and connected to the first communication passage 45a is smaller, smaller foam bubbles are produced. The foam thus produced flows through the discharge passage 43a and the downstream-side flow passage of the first flow passage 12a to be spouted out through the first spout port 13a. Through the second spout port 13b, neither water nor foam is spouted out.

In the case B, the water stop valve 3a is placed in the closed state, and the water stop valve 3b is placed in the open state. Accordingly, water is supplied to the second water supply port 11b but is not supplied to the first water supply port 11a in the spouting instrument 1. The water supplied to the second water supply port 11b flows from the upstream side of the second flow passage 12b to the nozzle part 41b of the second ejector 4b, and is then pressurized in the nozzle part 41b to be squirted to the discharge passage 43b. Since the pressure in the nozzle part 41b is higher while the pressure in the discharge passage 43b is lower, air is drawn into the air suctioning chamber 42b. Into the air suctioning chamber 42b, air is drawn through an air passage constituted by the second communication passage 45b, the downstream side of the first flow passage 12a, and the first spout port 13a. In the second ejector 4b, the air drawn into the air suctioning chamber 42b is mixed with water squirted from the nozzle part 41b, so that foam is produced. Since the flow passage area of the connection port provided on the air suctioning chamber 42b and connected to the second communication passage 45b is larger, larger foam bubbles are produced. The foam thus produced flows through the discharge passage 43b and the downstream-side flow passage of the second flow passage 12b to be spouted out through the second spout port 13b. Through the first spout port 13a, neither water nor foam is spouted out.

In the case C, the water stop valve 3a is placed in the open state, and the water stop valve 3b is also placed in the open state. Accordingly, water is supplied to the first water supply port 11a and the second water supply port 11b in the spouting instrument 1. The water supplied to the first water supply port 11a flows from the upstream side of the first flow passage 12a to the nozzle part 41a of the first ejector 4a, and is then pressurized in the nozzle part 41a to be squirted to the discharge passage 43a; thereafter, the water flows through the discharge passage 43a and the downstream side of the first flow passage 12a to be spouted out through the first spout port 13a. The water supplied to the second water supply port 11b flows from the upstream side of the second flow passage 12b to the nozzle part 41b of the second ejector 4b, and is then pressurized in the nozzle part 41b to be squirted to the discharge passage 43b; thereafter, the water flows through the discharge passage 43b and the downstream side of the second flow passage 12b to be spouted out through the second spout port 13b. Since the downstream side of each of the first flow passage 12a and the second flow passage 12b is filled with water, air can be drawn into neither the air suctioning chamber 42a nor the air suctioning chamber 42b. Accordingly, the spouting instrument 1 spouts out water through the first spout port 13a and the second spout port 13b.

In the following, the features of the spouting instrument 1 according to the second embodiment will be described.

In the spouting instrument 1 according to the second embodiment, the air suctioning chamber 42a of the first ejector 4a communicates with the downstream side of the second flow passage 12b via the first communication passage 45a, and the air suctioning chamber 42b of the second ejector 4b communicates with the downstream side of the first flow passage 12a via the second communication passage 45b. Accordingly, the spouting instrument 1 can spout out foam through the first spout port 13a or the second spout port 13b, and can also spout out water through the first spout port 13a and the second spout port 13b. Also, when the flow passage area of the connection port provided on the air suctioning chamber 42a and connected to the first communication passage 45a is made different from the flow passage area of the connection port provided on the air suctioning chamber 42b and connected to the second communication passage 45b, the size of the foam bubbles spouted out through the first spout port 13a can be made different from the size of the foam bubbles spouted out through the second spout port 13b.

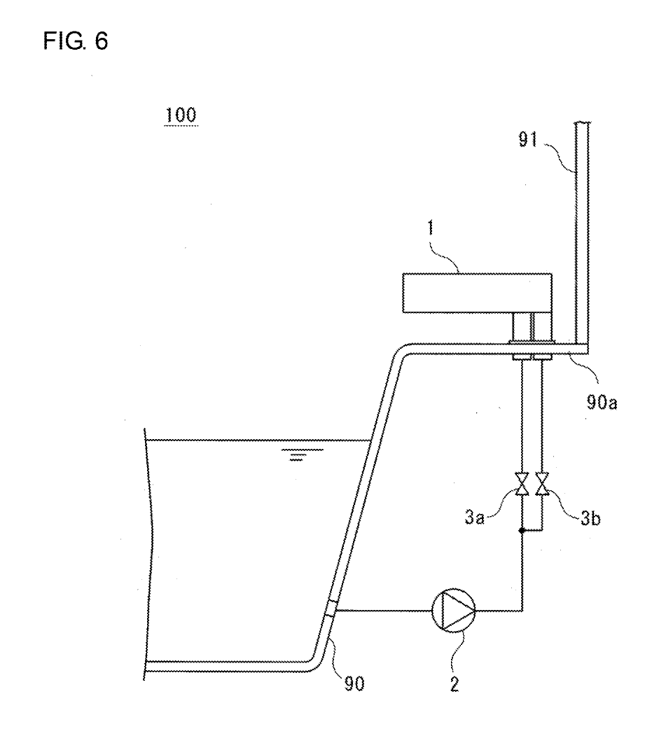

FIG. 6 is a schematic diagram used to describe another example regarding the arrangement of the spouting instrument 1. The spouting instrument 1 shown in FIG. 6 is mounted to the flange part 90a of the bathtub 90 at the water supply pipe portions on which the water supply ports are formed, in the same way as described in the aforementioned embodiment, but the trunk portion, in which the flow passages leading to the spout ports are formed, is positioned to be spaced away from the bathtub 90.

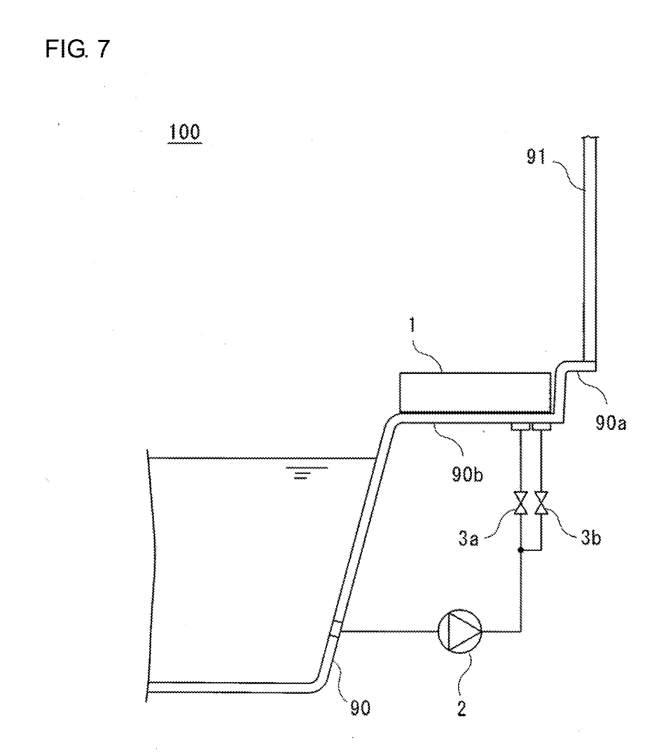

FIG. 7 is a schematic diagram used to describe yet another example regarding the arrangement of the spouting instrument 1. For the spouting instrument 1 shown in FIG. 7, a step part 90b, which is one step lower than the flange part 90a of the bathtub 90, is formed, and the spouting instrument 1 is arranged on the surface side of the step part 90b of the bathtub.

The first invention has been described with reference to embodiments. The embodiments are intended to be illustrative only, and it will be obvious to those skilled in the art that various modifications and changes could be developed within the scope of claims of the first invention and that such modifications and changes also fall within the scope of claims of the first invention. Therefore, the description in the present specification and the drawings should be regarded as exemplary rather than limitative.

Although there has been described an example in which the spouting instrument 1 includes multiple water supply ports, spout ports, flow passages, and ejectors, the spouting instrument 1 may include only a single water supply port, spout port, flow passage, and ejector.

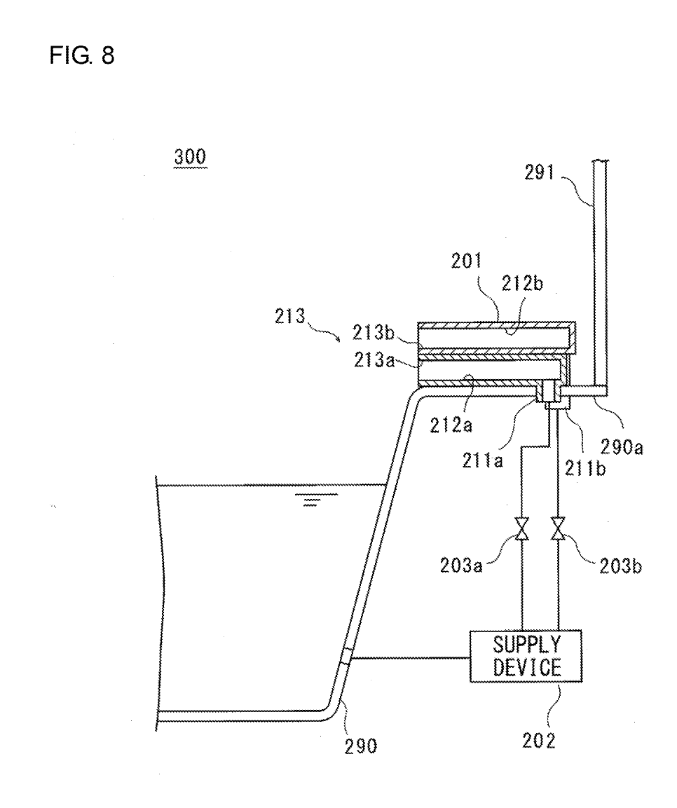

There will now be described the second invention based on a preferred embodiment with reference to FIGS. 8 through 11.

### Third Embodiment

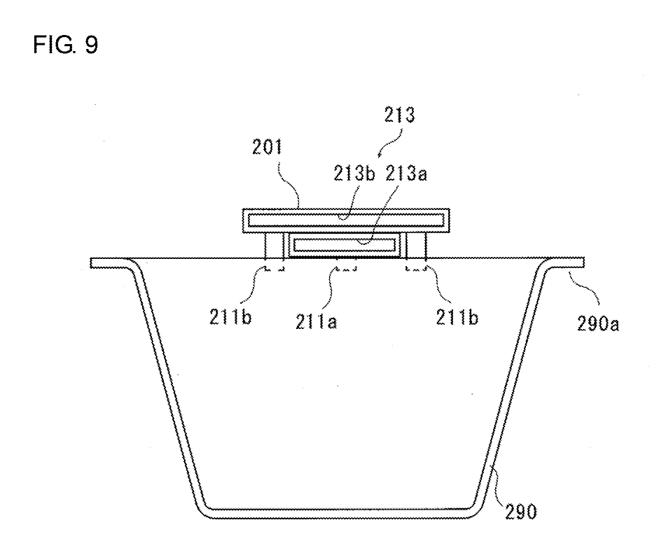

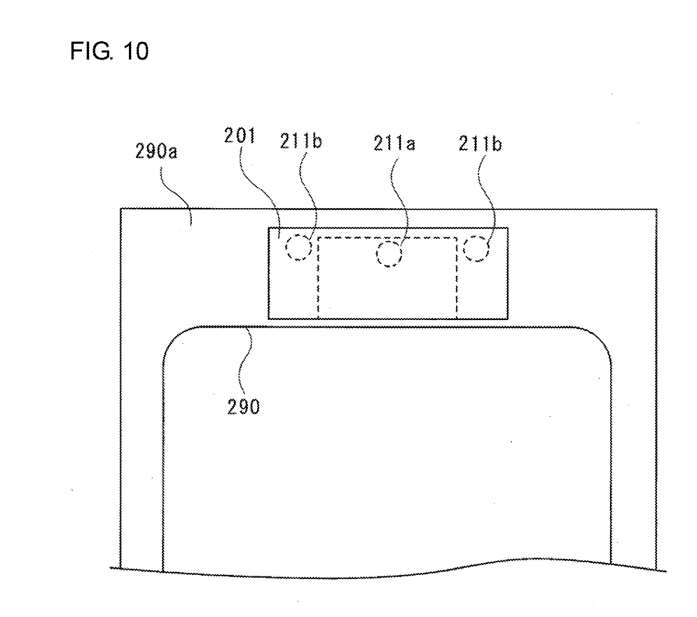

FIG. 8 is a configuration diagram of a bathtub device 300 including a spouting instrument 201 according to the third embodiment, FIG. 9 is a front view of the spouting instrument 201, and FIG. 10 is a plan view of the spouting instrument 201. The bathtub device 300 comprises a bathtub 290 that stores hot water, a wall panel 291, the spouting instrument 201, a supply device 202, and water stop valves 203a and 203b. The spouting instrument 201 is mounted to a flange part 290a of the bathtub 290, and the bathtub 290 receives water and foam spouted out from the spouting instrument 201. The wall panel 291 is mounted on the flange part 290a of the bathtub 290. The wall panel 291 and other wall panels surround the bathtub 290 and the washing place, not illustrated, on all sides, thereby forming a bathroom space.

The supply device 202 is a pump device that suctions water stored in the bathtub 290 and supplies water and foam to the spouting instrument 201. The pipes through which water is supplied from the supply device 202 to the spouting instrument 201 are connected to the spouting instrument 201 via the water stop valves 203a and 203b. The supply device 202 and the water stop valves 203a and 203b are provided on the rear side of the bathtub 290. Meanwhile, the spouting instrument 201 is mounted on the surface side of the bathtub 290, which is the inner side of the bathroom space.

The spouting instrument 201 comprises a first inflow pipe 211a, second inflow pipes 211b, a first flow passage 212a, a second flow passage 212b, a first spout port 213a, and a second spout port 213b. The first inflow pipe 211a is connected to the pipe extending from the water stop valve 203a. Also, the second inflow pipes 211b are connected to the pipes extending from the water stop valve 203b. The first inflow pipe 211a and the second inflow pipes 211b are inserted into holes provided on the flange part 290a of the bathtub 290 to be fixed. The second inflow pipes 211b are arranged in a direction intersecting the flowing direction of the first flow passage 212a, which will be described later, with respect to the first inflow pipe 211a. The first spout port 213a and the second spout port 213b are provided at positions facing the same direction from the spouting instrument 201. When the side on which the first spout port 213a and the second spout port 213b are provided is defined as the front side and when the spouting instrument 201 is viewed from the front, the second inflow pipes 211b are provided on both sides of the first inflow pipe 211a. From another perspective, using a width direction of the spout ports 213, the second inflow pipes 211b are provided on both sides of the first inflow pipe 211a in the width direction. The second inflow pipes 211b are provided at two positions on the left and right sides when the spouting instrument 201 is viewed from the front, and the pipe downstream from the water stop valve 203b is bifurcated and connected to the second inflow pipes 211b. Alternatively, only a single second inflow pipe 211b may be provided.

The first flow passage 212a communicates, on one end side thereof, with the inflow passage within the first inflow pipe 211a and is provided with the first spout port 213a on the other end side thereof. The first spout port 213a faces the bathroom space side, and foam is spouted out through the first spout port 213a to the inside of the bathtub 290. The first flow passage 212a may include therein a broaden region as appropriate so that the flow velocity of the foam spouted out through the first spout port 213a can be made uniform in a width direction of the first spout port 213a. The second flow passage 212b communicates, on one end side thereof, with the inflow passages within the second inflow pipes 211b and is provided with the second spout port 213b on the other end side thereof. The second spout port 213b faces the bathroom space side, and water is spouted out through the second spout port 213b to the inside of the bathtub 290. Each of the first spout port 213a and the second spout port 213b has a slit shape wide in one direction. The second flow passage 212b may include therein a broaden region as appropriate so that the flow velocity of the water spouted out through the second spout port 213b can be made uniform in a width direction of the second spout port 213b.

The spout ports 213 of the spouting instrument 201 are configured to be two tiers arranged vertically, in which the first spout port 213a is provided on the lower tier side, and the second spout port 213b is provided on the upper tier side. The second spout port 213b is wider than the first spout port 213a. Foam is spouted out through the first spout port 213a, while water is spouted out through the second spout port 213b. The first spout port 213a is arranged at a height close to the height of the bathtub 290 or the surface of the flange part 290a. Also, the second spout port 213b may be suitably arranged at a height such that the spouted water cascades down over the shoulders of the bathing person.

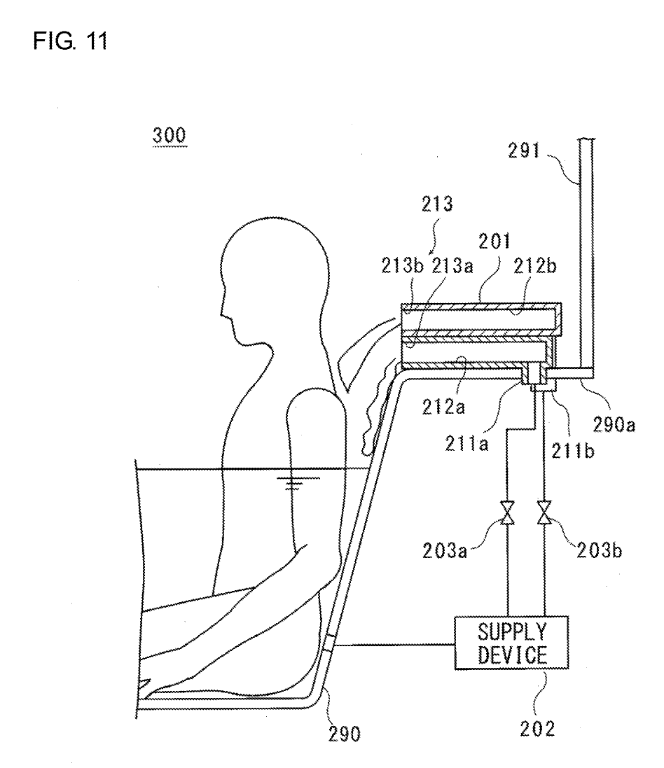

There will now be described the operation of the spouting instrument 201. FIG. 11 is a schematic diagram used to describe a state where the spouting instrument 201 is used. When the water stop valve 203a is placed in the open state and the water stop valve 203b is placed in the closed state, foam supplied from the supply device 202 through the first inflow pipe 211a flows through the first flow passage 212a to be spouted out through the first spout port 213a to the bathtub 290. Through the second spout port 213b, water is not spouted out.

The first spout port 213a is provided on the lower tier side of the spout ports 213 and arranged at a height close to the height of the bathtub 290 or the surface of the flange part 290a. Accordingly, the height from which the foam spouted out through the first spout port 213a toward the bathtub 290 flows down is small, thereby restraining the occurrence of re-bubbling. Also, since water is not spouted out through the second spout port 213b, the foam spouted out through the first spout port 213a will not be burst by water.

When the water stop valve 203a is placed in the closed state and the water stop valve 203b is placed in the open state, water supplied from the supply device 202 through the second inflow pipes 211b flows through the second flow passage 212b to be spouted out through the second spout port 213b to the bathtub 290. Through the first spout port 213a, foam is not spouted out.

The second spout port 213b is provided on the upper tier side of the spout ports 213 and arranged at a position slightly higher than the bathtub 290 or the flange part 290a. The water spouted out through the second spout port 213b is adjusted to cascade down over the shoulders of the bathing person by moderately setting the flow velocity of the water. Since the second spout port 213b is wider than the first spout port 213a, the water can be provided over the entire width of the bathing person's shoulders.

As described previously, the second inflow pipes 211b are arranged in a direction intersecting the flowing direction of the first flow passage 212a with respect to the first inflow pipe 211a. When the spouting instrument 201 is viewed from the front, the second inflow pipes 211b are provided on both sides of the first inflow pipe 211a. Meanwhile, with regard to the flange part 290a of the bathtub 290, the dimension between the inner peripheral edge of the bathtub 290 and the wall panel 291 is limited. Accordingly, the dimension of the spouting instrument 201 in the flowing direction of the first flow passage 212a and the second flow passage 212b is desirably smaller. Therefore, each of the second inflow pipes 211b is provided on a side of the first inflow pipe 211a when the spouting instrument 201 is viewed from the front. Also, since the second spout port 213b is wider than the first spout port 213a, by providing two second inflow pipes 211b to allow water to flow into the second flow passage 212b through the two pipes arranged in a width direction, the flow velocity of the water spouted out through the second spout port 213b can be made more uniform.

In the following, the features of the spouting instrument 201 according to the third embodiment will be described.

The spouting instrument 201 according to the third embodiment spouts out water and foam to the bathtub 290. The spout ports 213 of the spouting instrument 201 are separated into two tiers arranged vertically, in which foam is spouted out through the first spout port 213a on the lower tier side, and water is spouted out through the second spout port 213b on the upper tier side. Accordingly, the first spout port 213a of the spouting instrument 201 is provided on the lower tier side and arranged at a height close to the height of the bathtub 290 or the surface of the flange part 290a, thereby restraining re-bubbling caused when the foam bubbles spouted out through the first spout port 213a collide with the surface of the bathtub 290.

When the spouting instrument 201 is mounted on the bathtub 290, the water spout position, i.e., the second spout port 213b, is arranged at a certain height (a position in a vertical direction) such that the water spouted out through the second spout port 213b of the spouting instrument 201 cascades down over the shoulders of the bathing person. In the spouting instrument 201, while the water spout position is arranged at the height as described above, the foam spout position, i.e., the first spout port 213a, can be arranged at a position lower than the water spout position. When the foam spout position is located lower, the distance between the foam spout position and a position where foam bubbles collide (such as the surface of the bathtub 290) becomes shorter, thereby further restraining re-bubbling. Therefore, when the water spout position is arranged at a certain height, the foam spout position can be arranged lower than the water spout position, so that re-bubbling can be further restrained compared to the case where the water spout position and the foam spout position are the same. Thus, according to the third embodiment, the spouting instrument 201 suitable for restraining re-bubbling can be provided.

Also, since the second spout port 213b is wider than the first spout port 213a in the spouting instrument 201, water can be provided over the entire width of the bathing person's shoulders.

Also, the spouting instrument 201 includes the first inflow pipe 211a and the second inflow pipes 211b, which are inserted into holes provided on the bathtub 290 to be fixed. While the first spout port 213a is formed at one end part of the first flow passage 212a, the first inflow pipe 211a is connected to the other end part of the first flow passage 212a. Also, while the second spout port 213b is formed at one end part of the second flow passage 212b, each of the second inflow pipes 211b is connected to the other end part of the second flow passage 212b. Each of the second inflow pipes 211b is provided on a side of the first inflow pipe 211a. Accordingly, the dimension of the spouting instrument 201 in the flowing direction of the first flow passage 212a and the second flow passage 212b can be made smaller, so that the spouting instrument 201 can be made to have a size that fits onto the flange part 290a of the bathtub 290, of which the dimension between the inner peripheral edge of the bathtub 290 and the wall panel 291 is limited.

Also, the second inflow pipes 211b of the spouting instrument 201 are provided on both sides of the first inflow pipe 211a. Since the second spout port 213b is wider than the first spout port 213a, by providing two second inflow pipes 211b to allow water to flow into the second flow passage 212b through the two pipes arranged in a width direction, the flow velocity of the water spouted out through the second spout port 213b can be made more uniform.

The second invention has been described with reference to an embodiment. The embodiment is intended to be illustrative only, and it will be obvious to those skilled in the art that various modifications and changes could be developed within the scope of claims of the second invention and that such modifications and changes also fall within the scope of claims of the second invention. Therefore, the description in the present specification and the drawings should be regarded as exemplary rather than limitative.

The supply device 202 may also be the type that receives water from a hot water supply device, besides the type that uses the circulation of the water stored in the bathtub 290 as shown in FIG. 8. Also, the supply device 202 may be the type that supplies water to the spouting instrument 201, and, in this case, a foam producing means, such as an ejector, may be provided within the spouting instrument 201 to produce foam. The foam producing means may produce foam by mixing air into water supplied from the supply device 202, within a flow passage of the spouting instrument, for example. The foam producing means is not limited to such an ejector.

The width of the second spout port 213b is not particularly limited. For example, the width of the second spout port 213b may be the same as or narrower than the width of the first spout port 213a. Also, the relative positions of the second inflow pipes 211b with respect to the first inflow pipe 211a are not particularly limited, and the second inflow pipes 211b may be provided on the front side or on the rear side with respect to the first inflow pipe 211a.

What is claimed is:

1. A spouting instrument mounted on the surface side of a bathtub, the spouting instrument comprising:
a first spout port through which water is spouted out to the bathtub;
a first water supply port to which water from a water supply source is supplied; and
a first flow passage through which water supplied through the first water supply port flows to the first spout port, wherein
the first flow passage includes a first ejector that mixes air into water flowing from the first water supply port to produce foam and sends the foam to the first spout port.

2. The spouting instrument of claim 1, further comprising:
a second spout port through which water is spouted out to the bathtub;
a second water supply port to which water from a water supply source is supplied; and
a second flow passage through which water supplied through the second water supply port flows to the second spout port, wherein:
the second flow passage includes a second ejector that mixes air into water flowing from the second water supply port to produce foam and sends the foam to the second spout port; and
the spouting instrument further comprises a communication passage through which the air suctioning chamber of the first ejector and the air suctioning chamber of the second ejector communicate with each other.

3. The spouting instrument of claim 1, further comprising:
a second spout port through which water is spouted out to the bathtub;
a second water supply port to which water from a water supply source is supplied; and
a second flow passage through which water supplied through the second water supply port flows to the second spout port, wherein:
the second flow passage includes a second ejector that mixes air into water flowing from the second water supply port to produce foam and sends the foam to the second spout port; and
the spouting instrument further comprises a first communication passage through which the air suctioning chamber of the first ejector communicates with a flow passage portion of the second flow passage downstream from the second ejector, and a second communication passage through which the air suctioning chamber of the second ejector communicates with a flow passage portion of the first flow passage downstream from the first ejector.

4. A spouting instrument that spouts out water and foam to a bathtub, the spouting instrument comprising spout ports separated into two tiers arranged vertically, in which foam is spouted out through a first spout port on the lower tier side, and water is spouted out through a second spout port on the upper tier side.

5. The spouting instrument of claim 4, wherein the second spout port is wider than the first spout port.

6. The spouting instrument of claim 4, further comprising:
a first inflow pipe inserted into a hole provided on the bathtub and connected to a first flow passage, the first spout port being formed at one end part of the first flow passage, the first inflow pipe being connected to the other end part of the first flow passage; and
a second inflow pipe inserted into a hole provided on the bathtub and connected to a second flow passage, the second spout port being formed at one end part of the second flow passage, the second inflow pipe being connected to the other end part of the second flow passage, wherein
the second inflow pipe is provided on a side of the first inflow pipe.

7. The spouting instrument of claim 5, further comprising:
a first inflow pipe inserted into a hole provided on the bathtub and connected to a first flow passage, the first spout port being formed at one end part of the first flow passage, the first inflow pipe being connected to the other end part of the first flow passage; and
a second inflow pipe inserted into a hole provided on the bathtub and connected to a second flow passage, the second spout port being formed at one end part of the second flow passage, the second inflow pipe being connected to the other end part of the second flow passage, wherein
the second inflow pipe is provided on a side of the first inflow pipe.

8. The spouting instrument of claim 6, wherein the second inflow pipe is provided on both sides of the first inflow pipe.

9. The spouting instrument of claim 7, wherein the second inflow pipe is provided on both sides of the first inflow pipe.
